(19) United States
(12) Patent Application Publication
(10) Pub. No.: US 2025/0239822 A1
(43) Pub. Date: Jul. 24, 2025

(54) COAXIAL CONNECTOR

(71) Applicant: JAPAN AVIATION ELECTRONICS INDUSTRY, LIMITED, Tokyo (JP)

(72) Inventor: Akira KIMURA, Tokyo (JP)

(73) Assignee: JAPAN AVIATION ELECTRONICS INDUSTRY, LIMITED, Tokyo (JP)

(21) Appl. No.: 18/961,711

(22) Filed: Nov. 27, 2024

(30) Foreign Application Priority Data
Jan. 22, 2024 (JP) 2024-007373

(51) Int. Cl. H01R 24/50

(52) U.S. Cl. CPC H01R 24/50

(57) ABSTRACT

An internal lower surface of a substrate receiving portion has a first surface, a second surface, and a step between the first and the second surfaces. A ground terminal has a first spring portion, an upper contact point, a second spring portion and a lower contact point. When a ground member is attached to a shell, the upper contact point and the lower contact point are in the substrate receiving portion. Upon attaching the ground member to the shell after insertion of a substrate into the substrate receiving portion, the lower contact point is moved from on the first surface to on the second surface, and thereby moving the upper contact point upward to be brought into contact with a ground layer of the substrate and pushing the substrate upward to bring a signal line of the substrate into contact with a rear contact portion of a signal contact.

### CROSS REFERENCE TO RELATED APPLICATIONS

This application is based on and claims priority under 35 U.S.C. § 119 to Japanese Patent Application No. JP2024-007373 filed Jan. 22, 2024, the contents of which are incorporated herein in their entirety by reference.

### BACKGROUND OF THE INVENTION

This invention relates to a coaxial connector and, in particular, relates to a coaxial connector attachable to a substrate.

JP 2009-99283 A (Patent Document 1) discloses an example of a coaxial connector attachable to a substrate.

Referring to FIGS. 25 and 26, a coaxial connector 90 of Patent Document 1 is provided with a flange 92. The flange 92 has a horizontal portion 921 and a vertical portion 923. The horizontal portion 921 of the flange 92 is formed with screw holes 925. The coaxial connector 90 is further provided with a connector core line 94.

As shown in FIGS. 25 and 26, when the coaxial connector 90 is attached to a substrate 96, screws 981 passing through through-holes 961 of the substrate 96 are screwed to the screw holes 925 of the horizontal portion 921. In addition, at this time, the connector core line 94 is connected and fixed to a circuit pattern 963 of the substrate 96 using solder 983.

The coaxial connector 90 of Patent Document 1 needs to be screwed and soldered to the substrate 96 when it is attached to the substrate 96. In other words, it needs tools to attach the coaxial connector 90 of Patent Document 1 to the substrate 96. Accordingly, there is a need for a coaxial connector which can be attached to a substrate without the use of tools.

### SUMMARY OF THE INVENTION

It is an object of the present invention to provide a coaxial connector which can be attached to a substrate without the use of tools.

One aspect of the present invention provides a coaxial connector which is attachable to a substrate. The substrate is formed with a signal line on an upper surface thereof and with a ground layer on a lower surface thereof. The coaxial connector comprises a front assembly and a rear assembly which is attachable to the front assembly from behind in a front-rear direction. The front assembly comprises a signal contact, a shell made of metal and an internal insulator insulating the signal contact from the shell. The shell is formed with a substrate receiving portion which opens rearward. The substrate receiving portion has an internal upper surface and an internal lower surface which are opposite to each other in an up-down direction perpendicular to the front-rear direction. The internal lower surface is provided with a first surface and a second surface. The first surface is located rearward of the second surface in the front-rear direction. The first surface is located downward of the second surface in the up-down direction so that a step is provided between the first surface and the second surface. The signal contact has a rear contact portion. The rear contact portion extends along the front-rear direction and is exposed in the substrate receiving portion at least in part. The rear assembly comprises a ground member made of metal. The ground member has a ground peripheral portion and a ground terminal. The ground peripheral portion is attachable to the shell from behind to cover a periphery of the shell. The ground terminal has a first spring portion which extends from the ground peripheral portion and is resiliently deformable, an upper contact point supported by the first spring portion, a second spring portion which extends from the upper contact point and is resiliently deformable and a lower contact point supported by the second spring portion. In an attached state that the ground member is attached to the shell, the upper contact point and the lower contact point are located in the substrate receiving portion. By attaching the ground member to the shell after passing the substrate through the ground peripheral portion and inserting the substrate into the substrate receiving portion, the lower contact point of the ground member rides over the step and is moved from the first surface onto the second surface, so that the upper contact point is moved upward and brought into contact with the ground layer of the substrate and pushes the substrate upward to bring the signal line of the substrate into contact with the rear contact portion of the signal contact.

The coaxial connector according to the above-mentioned aspect of the present invention is provided with above-mentioned structure, so that it can be attached to the substrate without the use of tools.

Moreover, in the coaxial connector according to the above-mentioned aspect of the present invention, the ground layer on the lower surface of the substrate can be electrically connected to the shell without the use of a screw or a via which passes through the substrate and is electrically connected to the ground layer on the lower surface. Alternately, in the coaxial connector according to the above-mentioned aspect of the present invention, when the substrate has a film shape, the ground layer on the lower surface of the substrate can be electrically connected to the shell without folding back the substrate in part to expose the ground layer on the lower surface of the substrate in part to a side of the upper surface of the substrate.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a coaxial connector according to an embodiment of the present invention and a substrate. A front assembly and a rear assembly of the coaxial connector are separated from each other. The coaxial connector is not attached to the substrate.

FIG. 2 is another perspective view showing the coaxial connector according to the embodiment of the present invention and the substrate.

FIG. 3 is an exploded, perspective view showing the coaxial connector shown in FIG. 1.

FIG. 4 is another exploded, perspective view showing the coaxial connector of FIG. 3.

FIG. 5 is a perspective, cross-sectional view showing the front assembly included in the coaxial connector shown in FIG. 1. The cross-section is on a plane which includes a central axis of a signal contact included in the coaxial connector and is perpendicular to a lateral direction or an X-direction. FIG. 6 is a perspective, cross-sectional view showing a rear shell included in the front assembly of FIG. 5.

FIG. 7 is a vertical, cross-sectional view showing the rear shell of FIG. 6.

FIG. 8 is a perspective view showing the signal contact included in the coaxial connector of FIG. 3.

FIG. 9 is a perspective view showing an internal insulator included in the coaxial connector of FIG. 3.

FIG. 10 is a perspective, cross-sectional view showing the internal insulator included in the front assembly of FIG. 5.

FIG. 11 is a perspective view showing a ground member included in the coaxial connector of FIG. 3.

FIG. 12 is a perspective, cross-sectional view showing the ground member of FIG. 11. The cross-section is on a plane which is perpendicular to the lateral direction or the X-direction and divides the ground member in half.

FIG. 13 is a vertical, cross-sectional view showing the ground member of FIG. 12.

FIG. 14 is a vertical, cross-sectional view showing the coaxial connector shown in FIG. 1. The cross-section is the plane which includes the central axis of the signal contact included in the coaxial connector and is perpendicular to the lateral direction or the X-direction. The rear assembly is positioned at a first position.

FIG. 15 is another vertical, cross-sectional view showing the coaxial connector of FIG. 14. The rear assembly is positioned at a second position.

FIG. 16 is a partial, vertical, cross-sectional view showing the coaxial connector and the substrate of FIG. 1. The cross-section is on a plane which is perpendicular to the lateral direction or the X-direction and includes one of edge faces of a coupling portion of the ground member included in the coaxial connector in the lateral direction. The rear assembly is positioned at the first position.

FIG. 17 is a vertical, cross-sectional view showing the coaxial connector of FIG. 14 and the substrate. One end portion of the substrate is inserted into a substrate receiving portion of the coaxial connector. The rear assembly is positioned at the first position.

FIG. 18 is a partial, cross-sectional view showing the coaxial connector and the substrate of FIG. 16. The rear assembly is positioned at the second position.

FIG. 19 is another vertical, cross-sectional view showing the coaxial connector and the substrate of FIG. 17. The rear assembly is positioned at the second position.

FIG. 20 is a rear view showing the coaxial connector and the substrate of FIG. 18. An external insulator of the coaxial connector is omitted.

FIG. 21 is a perspective, cross-sectional view showing the coaxial connector and the substrate of FIG. 18. The external insulator of the coaxial connector is omitted.

FIG. 22 is a perspective, cross-sectional view showing the coaxial connector and the substrate of FIG. 19. The external insulator of the coaxial connector is omitted.

FIG. 23 is a front view showing the coaxial connector of FIG. 15.

FIG. 24 is a vertical, cross-sectional view showing a modification of the ground member included in the coaxial connector according to the embodiment of the present invention. The cross-section is on the plane which is perpendicular to the lateral direction or the X-direction and divides the ground member in half.

FIG. 25 is a plan view showing a coaxial connector disclosed in Patent Document 1. The coaxial connector is attached to a substrate.

FIG. 26 is a side view showing the coaxial connector of FIG. 25.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

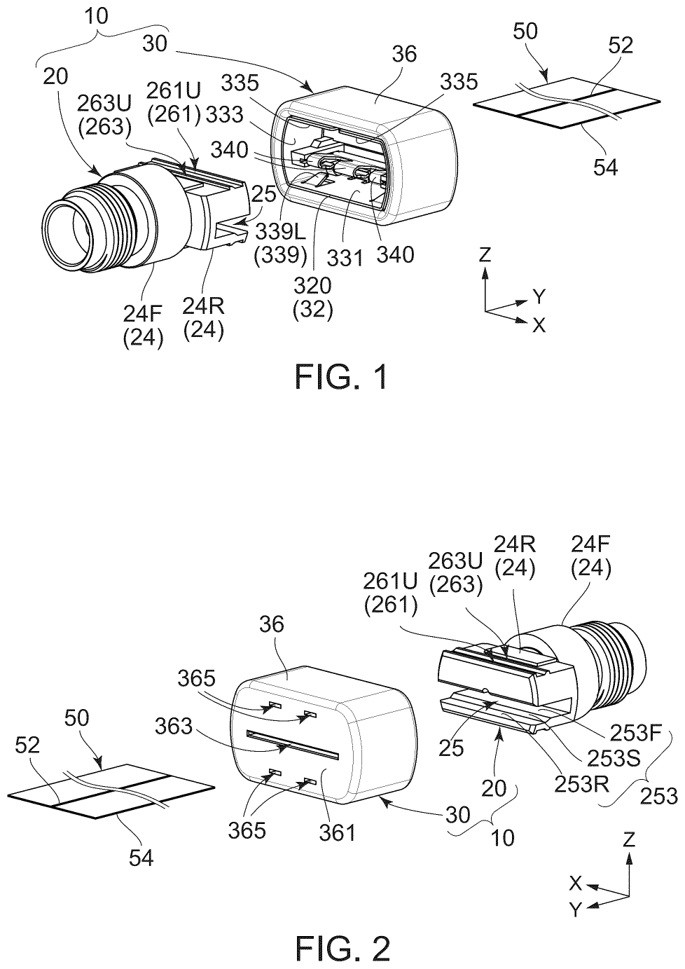

Referring to FIGS. 1 and 2, a coaxial connector 10 according to an embodiment of the present invention is provided with a front assembly 20 and a rear assembly 30. When the front assembly 20 is positioned forward of the rear assembly 30 in a front-rear direction, the rear assembly 30 is attachable to the front assembly 20 from behind. Moreover, the coaxial connector 10 according to the present embodiment is attachable to a substrate 50. The substrate 50 is insertable into the coaxial connector 10 from behind in the front-rear direction. In the present embodiment, the front-rear direction is a Y-direction. A negative Y-direction is directed forward while a positive Y-direction is directed rearward.

As shown in FIGS. 1 and 2, an upper surface of the substrate 50 is formed with a signal line 52. In the present embodiment, the signal line 52 is located at the middle of the substrate 50 in a lateral direction perpendicular to the front-rear direction and extends in the front-rear direction. In the present embodiment, the lateral direction is an X-direction. Moreover, a lower surface of the substrate 50 is formed with a ground layer 54. The ground layer 54 may be a solid pattern or a ground line pattern with a predetermined width. The ground layer 54 overlaps with the signal line 52 in an up-down direction and has a width wider than that of the signal line 52 in the lateral direction. In the present embodiment, the substrate 50 is flexible. However, the present invention is not limited thereto. In the present invention, the substrate 50 may be rigid. Moreover, the upper surface of the substrate 50 may be formed with other conductive patterns, such as ground patterns, in addition to the signal line 52. The ground patterns may be formed on both sides of the signal line 52 in the lateral direction so that they are apart from the signal line 52 and sandwich the signal line 52.

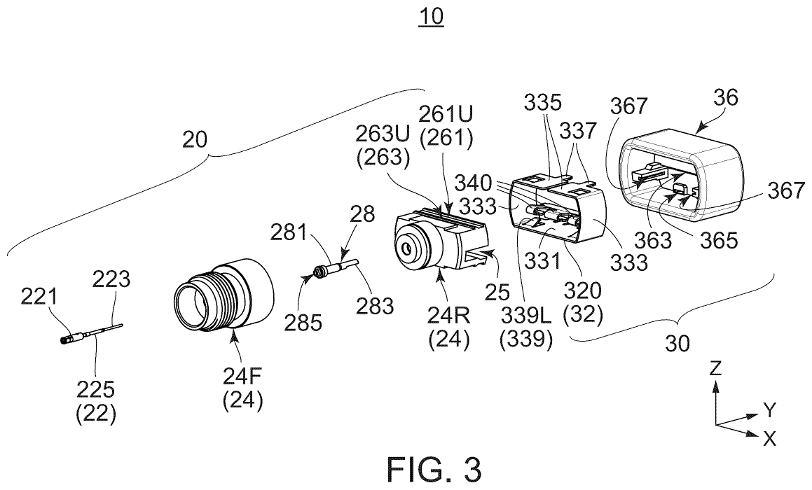

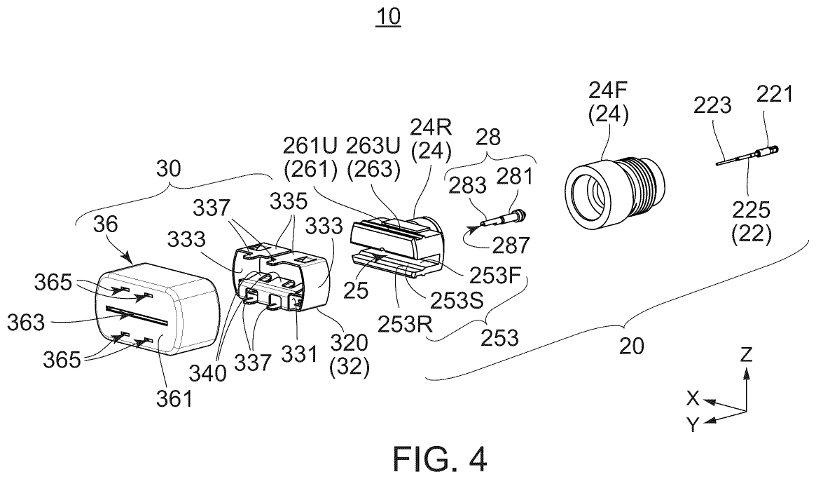

Referring to FIGS. 3 and 4, the front assembly 20 is provided with a signal contact 22, a shell 24 and an internal insulator 28. In the present embodiment, each of the signal contact 22 and the shell 24 is made of metal. The internal insulator 28 is made of insulating resin. In the present embodiment, the shell 24 consists of a front shell 24F and a rear shell 24R. However, the present invention is not limited thereto. The shell 24 may be formed as a single piece.

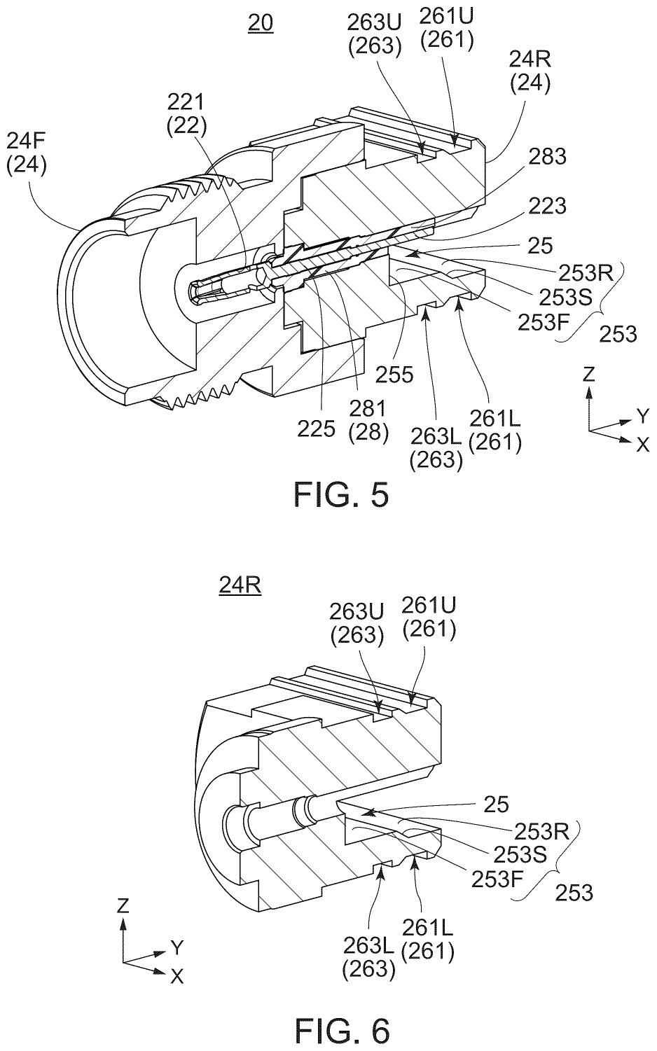

As shown in FIG. 5, the signal contact 22 is held by the internal insulator 28. Moreover, the internal insulator 28 is held by the shell 24. In detail, approximately the whole of the internal insulator 28 is accommodated in the rear shell 24R, and the internal insulator 28 is sandwiched by the front shell 24F and the rear shell 24R in part. The rear the shell 24R is press-fit into the front shell 24F. Thus, since the shell 24 employs a two-piece structure in the present embodiment, the internal insulator 28 can be easily, securely held. The internal insulator 28 insulates between the signal contact 22 and the shell 24.

As shown in FIGS. 3 and 4, the rear assembly 30 is provided with a ground member 32 and an external insulator 36. The external insulator 36 holds the ground member 32. The ground member 32 is made of metal. The external insulator 36 is made of insulating resin. A rear wall 361 of the external insulator 36 is formed with an insertion opening 363 into which the substrate 50 is inserted. The insertion opening 363 pierces the rear wall 361 in the front-rear direction. However, the external insulator 36 is not essential in the present invention. In other words, the rear assembly 30 may consist only of the ground member 32. Nevertheless, when the rear assembly 30 is provided with the external insulator 36, the ground member 32 can be handled without a direct touch on the ground member 32.

As shown in FIGS. 5 to 7, the shell 24 is formed with a substrate receiving portion 25 which receives the substrate 50 in part. In the present embodiment, the substrate receiving portion 25 is formed in the rear shell 24R. The substrate receiving portion 25 opens rearward. In the present embodiment, the substrate receiving portion 25 further opens in the lateral direction. However, the present invention is not limited thereto. The substrate receiving portion 25 may close in the lateral direction. Nevertheless, when the substrate receiving portion 25 opens in the lateral direction, it is easier to be manufactured.

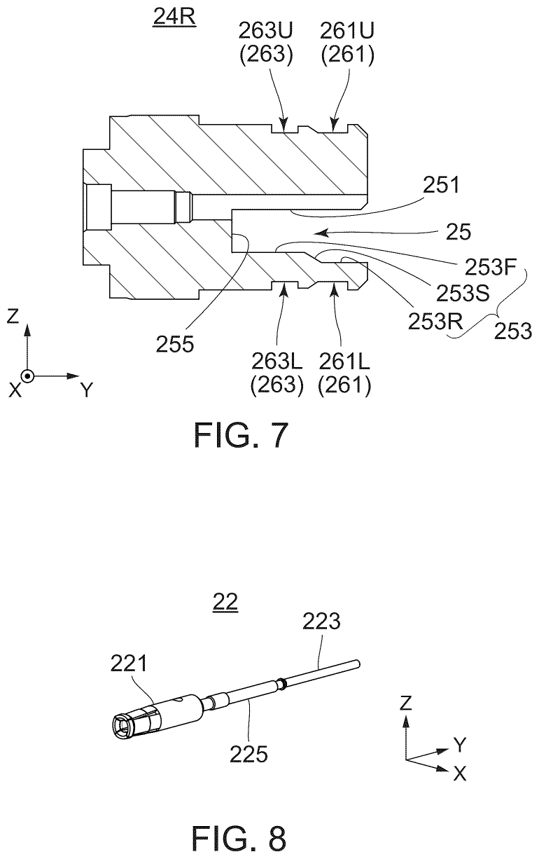

As shown in FIG. 7, the substrate receiving portion 25 has an internal upper surface 251 and an internal lower surface 253 which are apart from and opposite to each other in the up-down direction perpendicular to both the front-rear direction and the up-down direction. In other words, the shell 24 or the rear shell 24R has the internal upper surface 251 and the internal lower surface 253 which are apart from and opposite to each other in the up-down direction and which defines the substrate receiving portion 25 in part. In the present embodiment, the internal upper surface 251 is a surface perpendicular to the up-down direction. Moreover, the shell 24 or the rear shell 24R has a front surface 255 which defines a front end of the substrate receiving portion 25. In the present embodiment, the front surface 255 is a surface perpendicular to the front-rear direction. Note that the up-down direction is a Z-direction in the present embodiment. A positive Z-direction is directed upward while a negative Z-direction is directed downward.

As understood from FIG. 7, the internal lower surface 253 is provided with a first surface 253R and a second surface 253F. In the present embodiment, each of the first surface 253R and the second surface 253F is a surface perpendicular to the up-down direction. The first surface 253R is located rearward of the second surface 253F in the front-rear direction. Moreover, the first surface 253R is located downward of the second surface 253F in the up-down direction. In addition, a step 253S is provided between the first surface 253R and the second surface 253F. In the present embodiment, the step 253S is an oblique surface which continuously connects between the first surface 253R and the second surface 253F. However, the present invention is not limited thereto. The step 253S may be a vertical surface which continuously connects between the first surface 253R and the second surface 253F and is perpendicular to the front-rear direction.

As shown in FIG. 7, the rear shell 24R or the shell 24 is provided with a first hollow portion 261 and a second hollow portion 263 each of which is depressed inward in a perpendicular plane perpendicular to the front-rear direction. In the front-rear direction, the first hollow portion 261 is located rearward of the second hollow portion 263. In the present embodiment, the first hollow portion 261 has a first upper hollow portion 261U and a first lower hollow portion 261L, and the second hollow portion 263 has a second upper hollow portion 263U and a second lower hollow portion 263L. The first upper hollow portion 261U and the second upper hollow portion 263U are formed on an upper rear portion of the rear shell 24R, and the first lower hollow portion 261L and the second lower hollow portion 263L are formed on a lower rear portion of the rear shell 24R. In the present embodiment, the first hollow portion 261 and the second hollow portion 263 are grooves which extend in the lateral direction and are depressed inward in the up-down direction. The first hollow portion 261 has a cross-sectional shape of a trapezoid. The first hollow portion 261 may have the cross-sectional shape of a rectangle. The second hollow portion 263 has a cross-sectional shape of a rectangle. An internal rear surface of each of the first hollow portion 261 and the second hollow portion 263 is a surface perpendicular to the front-rear direction.

As shown in FIG. 8, the signal contact 22 has a front contact portion 221, a rear contact portion 223 and a middle portion 225. The front contact portion 221 has a socket contact portion of a slotted type. The socket contact portion opens forward in the front-rear direction. The rear contact portion 223 has a cylindrical column shape. The rear contact portion 223 extends rearward along the front-rear direction. The middle portion 225 couples the front contact portion 221 and the rear contact portion 223 to each other. The front contact portion 221, the middle portion 225 and the rear contact portion 223 continuously extend in the front-rear direction.

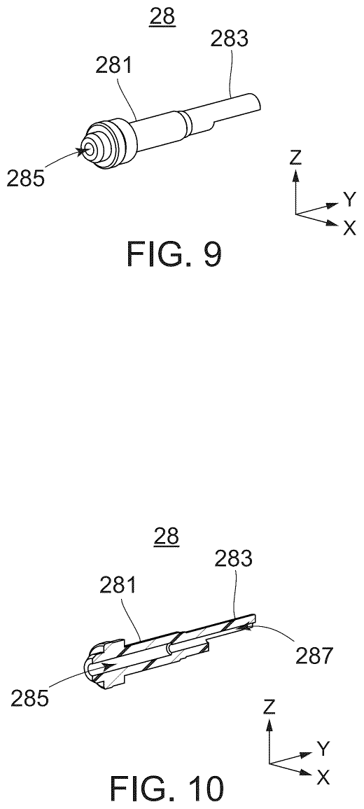

Referring to FIG. 9, the internal insulator 28 has a main portion 281 and a reinforcing portion 283 protruding rearward from the main portion 281. The main portion 281 has a rotationally symmetrical shape with respect to an imaginary axis extending in the front-rear direction. The reinforcing portion 283 has a shape which coincides with a half of a cylinder which is rotationally symmetrical with respect to the imaginary axis extending in the front-rear direction.

As shown in FIG. 10, the main portion 281 has a contact accommodation portion 285 which pierces the main portion 281 along the front-rear direction.

Moreover, the reinforcing portion 283 has a contact accommodation groove 287 which is contiguous with the contact accommodation portion 285 and extends in the front-rear direction.

As understood from FIG. 5 in addition to FIG. 10, the contact accommodation portion 285 of the main portion 281 of the internal insulator 28 accommodates the middle portion 225 of the signal contact 22 and a part of the rear contact portion 223. Moreover, the contact accommodation groove 287 of the reinforcing portion 283 of the internal insulator 28 accommodates the rear contact portion 223 of the signal contact 22 in part. The reinforcing portion 283 covers an upper portion of the rear contact portion 223 protruding from the main portion 281. However, the reinforcing portion 283 is not essential in the present invention. Nevertheless, the reinforcing portion 283 is located between the shell 24 and the rear contact portion 223, and it prevents the rear contact portion 223 of the signal contact 22 from being deformed and makes isolation between the shell 24 and the signal contact 22 sure.

As shown in FIG. 5, the internal insulator 28 holding the signal contact 22 is held by the shell 24. A lower portion of the part of the rear contact portion 223 which protrudes from the main portion 281 of the internal insulator 28 extends rearward of the front surface 255 of the substrate receiving portion 25 and is exposed in the substrate receiving portion 25. Thus, in the present embodiment, the rear contact portion 223 is exposed in the substrate receiving portion 25 at least in part.

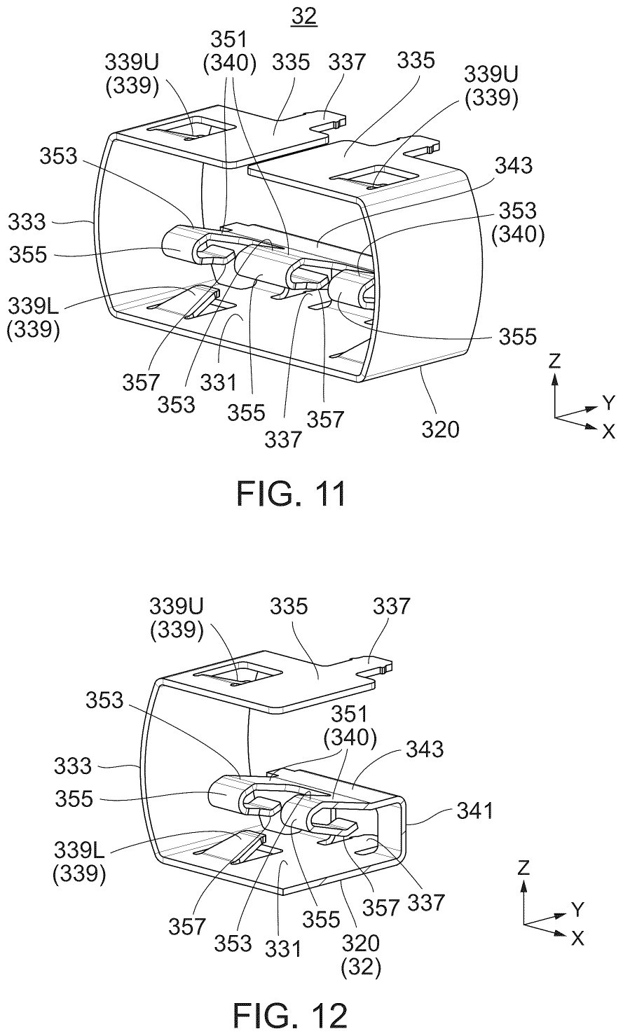

Referring to FIGS. 11 and 12, the ground member 32 has a ground peripheral portion 320 and at least one ground terminal 340. The ground peripheral portion 320 has a lower plate portion 331, a pair of side plate portions 333 and a pair of upper plate portions 335. The ground peripheral portion 320 has an approximately racetrack shape when viewed along the front-rear direction. The ground terminals 340 are located inside the ground peripheral portion 320 when viewed along the front-rear direction.

Referring to FIG. 4 in addition to FIG. 11, the ground peripheral portion 320 has at least one held portion 337 protruding rearward. In the present embodiment, the number of the held portions 337 is four. In detail, the lower plate portion 331 is formed with two held portions 337, and each of the upper plate portions 335 is formed with one held portion 337. Moreover, the ground peripheral portion 320 is formed with protruding portions 339 protruding inward in a perpendicular plane perpendicular to the front-rear direction. In the present embodiment, the protruding portions 339 include lower protruding portions 339L formed on the lower plate portion 331 and upper protruding portions 339U formed on the upper plate portions 335. Moreover, in the present embodiment, the protruding portions 339 are lances formed by cutting and raising the ground peripheral portion 320. Each of the lower protruding portions 339L extends backward-diagonally upward, and each of the upper protruding portions 339U extends backward-diagonally downward. The protruding portions 339 perform positioning and electrical connection to the shell 24.

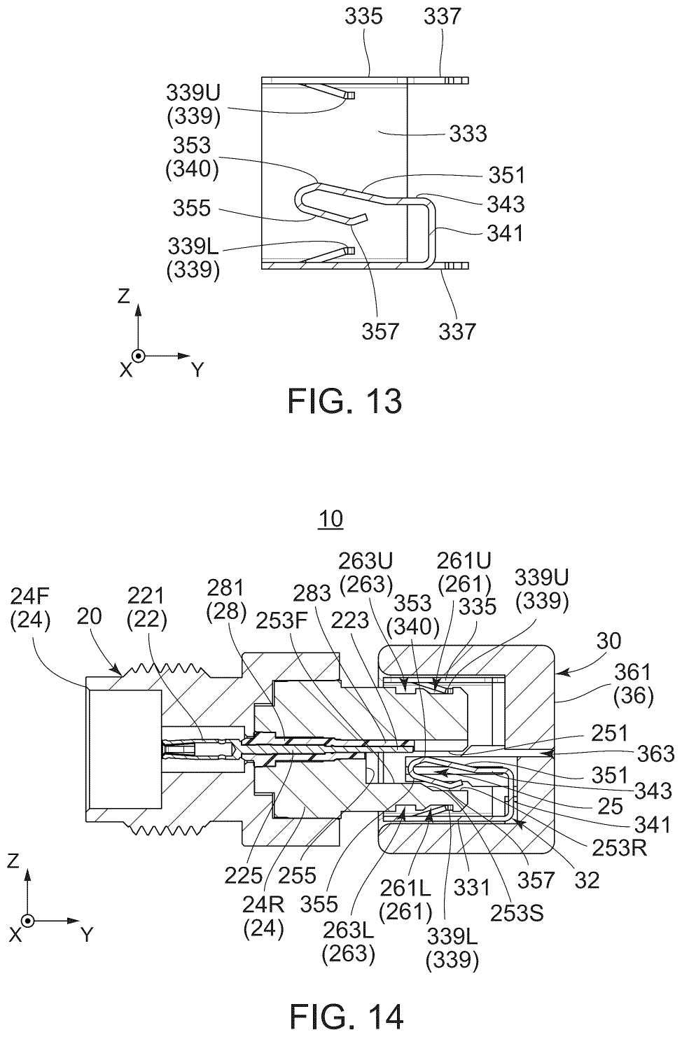

As shown in FIG. 11, in the present embodiment, the at least one ground terminal 340 is three in number. As understood from FIGS. 12 and 13, each of the ground terminals 340 extends from the ground peripheral portion 320. In the present embodiment, the ground terminals 340 extend from the lower plate portion 331 of the ground peripheral portion 320.

As understood from FIGS. 11, 12 and 20, each of the ground terminals 340 has a base portion 341. As shown in FIG. 13, the base portions 341 extend upward from the ground peripheral portion 320. As shown in FIG. 11, the base portions 341 are coupled to one another with a coupling portion 343. The coupling portion 343 extends forward from upper ends of the base portions 341. As understood from FIGS. 13, 16 and 18, each of both end portions of the coupling portion 343 in the lateral direction is partly inserted into and held by a holding groove 367 provided on the external insulator 36.

As shown in FIG. 13, each of the ground terminals 340 further has a first spring portion 351, an upper contact point 353, a second spring portion 355 and a lower contact point 357.

As shown in FIG. 13, the first spring portion 351 extends forward from a front edge of the coupling portion 343. The first spring portion 351 is resiliently deformable and supports the upper contact point 353. In the present embodiment, the upper contact point 353 is a part of a surface of the first spring portion 351. The upper contact point 353 is located upward of the lower contact point 357 in the up-down direction and directed upward in the up-down direction. Because of resilient deformation of the first spring portion 351, the upper contact point 353 can be moved at least in the up-down direction.

As shown in FIG. 13, the second spring portion 355 extends forward from the upper contact point 353, then extends downward, and further extends rearward in the front-rear direction. The second spring portion 355 is resiliently deformable and supports the lower contact point 357. In the present embodiment, the lower contact point 357 is a part of a surface of the second spring portion 355. The lower contact point 357 is directed downward in the up-down direction. Because of resilient deformation of the second spring portion 355, the lower contact point 357 can be moved at least in the up-down direction. The lower contact point 357 is located rearward of the upper contact point 353 in the front-rear direction. This structure makes it possible to reduce a size of the rear assembly 30 in the front-rear direction.

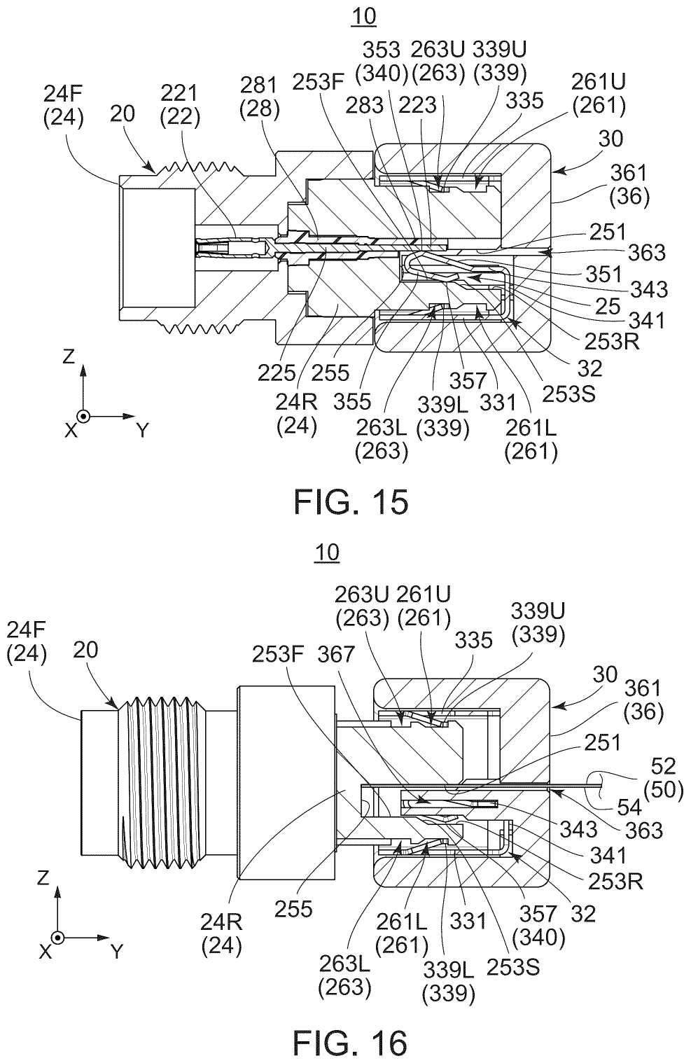

As understood from FIGS. 14 and 15, the ground member 32 is held by the external insulator 36. As shown in FIG. 4, the external insulator 36 is provided with holding apertures 365 which correspond to the held portions 337 of the ground member 32, respectively. By inserting the held portions 337 of the ground member 32 into the holding apertures 365 corresponding to them, respectively, the ground member 32 is held by the external insulator 36 to form the rear assembly 30.

As understood from FIGS. 3 and 4, the ground member 32 is attachable to the shell 24 from a rear of the shell 24. In detail, the ground peripheral portion 320 of the ground member 32 is attachable to the shell 24 so that it covers a periphery of the shell 24 in a plane perpendicular to the front-rear direction. In the present embodiment, the ground member 32 is attached to the shell 24. In other words, in the present embodiment, the rear assembly 30 is attached to the front assembly 20. However, the present invention is not limited thereto. When the coaxial connector 10 is not attached to the substrate 50, the ground member 32 or the rear assembly 30 may be in a state that it is detached from the shell 24 or the front assembly 20.

As understood from FIGS. 14 and 15, the rear assembly 30 is attached to the front assembly 20 so that it can be moved from a first position (FIG. 14) to a second position (FIG. 15) in the front-rear direction. Here, the first position is located rearward of the second position in the front-rear direction.

As shown in FIG. 14, when the rear assembly 30 is positioned at the first position, the protruding portions 339 of the ground member 32 are received by the first hollow portion 261 of the rear shell 24R. In detail, the upper protruding portions 339U are positioned in the first upper hollow portion 261U in part, and the lower protruding portions 339L are positioned in the first lower hollow portion 261L in part. Incidentally, in FIG. 14, one of the upper protruding portions 339U and one of the lower protruding portions 339L are depicted. If an attempt is made to move the rear assembly 30 rearward with respect to the front assembly 20 while the rear assembly 30 is positioned at the first position, the protruding portions 339 are brought into abutment with an inner rear surface of the first hollow portion 261. Accordingly, the rear assembly 30 cannot be moved rearward with respect to the front assembly 20.

As shown in FIGS. 14 and 15, regardless of whether the rear assembly 30 is positioned at the first position or at the second position, at least both the upper contact points 353 and the lower contact points 357 of the ground terminals 340 are positioned in the substrate receiving portion 25 in an attached state that the ground member 32 is attached to the shell 24. Incidentally, in each of FIGS. 14 and 15, one of the ground terminals 340 is depicted.

As shown in FIG. 14, when the rear assembly 30 is positioned at the first position, the lower contact points 357 face the first surface 253R of the internal lower surface 253 of the substrate receiving portion 25. The lower contact points 357 may be brought into contact with the first surface 253R or may be apart from the first surface 253R. In the present embodiment, the lower contact points 357 are apart from the first surface 253R. At any rate, when the rear assembly 30 is positioned at the first position, the lower contact points 357 are positioned on or above the first surface 253R. Moreover, the upper contact points 353 face the internal upper surface 251 of the substrate receiving portion 25. The upper contact points 353 may be brought into contact with the internal upper surface 251 or may be apart from the internal upper surface 251. Nevertheless, it is preferable that the upper contact points 353 are apart from the internal upper surface 251 because an insertion force necessary for inserting the substrate 50 is smaller. In particular, the insertion force necessary for inserting the substrate 50 can be equal to zero when the upper contact points 353 are positioned downward of the insertion opening 363 of the external insulator 36 in the up-down direction.

As understood from FIGS. 14 and 15, upon moving the rear assembly 30 from the first position to the second position, the protruding portions 339 of the ground member 32 are resiliently deformed and come out from the first hollow portion 261 of the rear shell 24R to be moved to and received by the second hollow portion 263. In detail, the upper protruding portions 339U are received by the second upper hollow portion 263U, and the lower protruding portions 339L are received by the second lower hollow portion 263L. If an attempt is made to move the rear assembly 30 rearward with respect to the front assembly 20 while the rear assembly 30 is positioned at the second position, the protruding portions 339 is brought into abutment with an internal rear surface of the second hollow portion 263. Accordingly, the rear assembly 30 cannot be moved rearward with respect to the front assembly 20.

As understood from FIG. 15, when the rear assembly 30 is positioned at the second position, the protruding portions 339 and the second hollow portion 263 are brought into contact with each other, and thereby electrically connecting the ground peripheral portion 320 to the shell 24. Connection of the shell 24 to the ground member 32 improves high-frequency characteristics of the coaxial connector 10. Moreover, provision of the plural ground terminals 340 increases connection paths between the shell 24 and the ground member 32 and further improves the high-frequency characteristics of the coaxial connector 10.

As understood from FIGS. 14 and 15, when the rear assembly 30 is moved from the first position to the second position, the lower contact points 357 ride over the step 253S and run onto the second surface 253F of the internal lower surface 253 of the substrate receiving portion 25. Thus, the second spring portions 355 are resiliently deformed and push one ends of the first spring portions 351 upward. As a result, the first spring portions 351 are resiliently deformed and push the upper contact points 353 upward. In the up-down direction, a distance between the upper contact points 353 and the rear contact portion 223 of the signal contact 22 is set to be equal to or less than a thickness of the substrate 50. In this case, the upper contact points 353 may be brought into contact with the rear contact portion 223 of the signal contact 22.

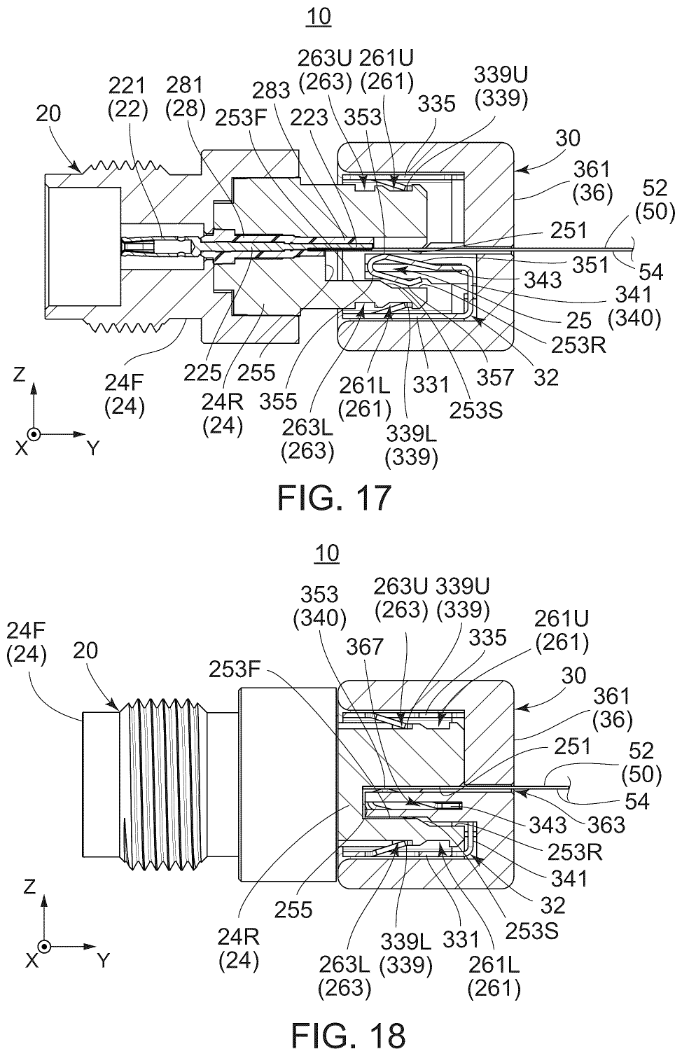

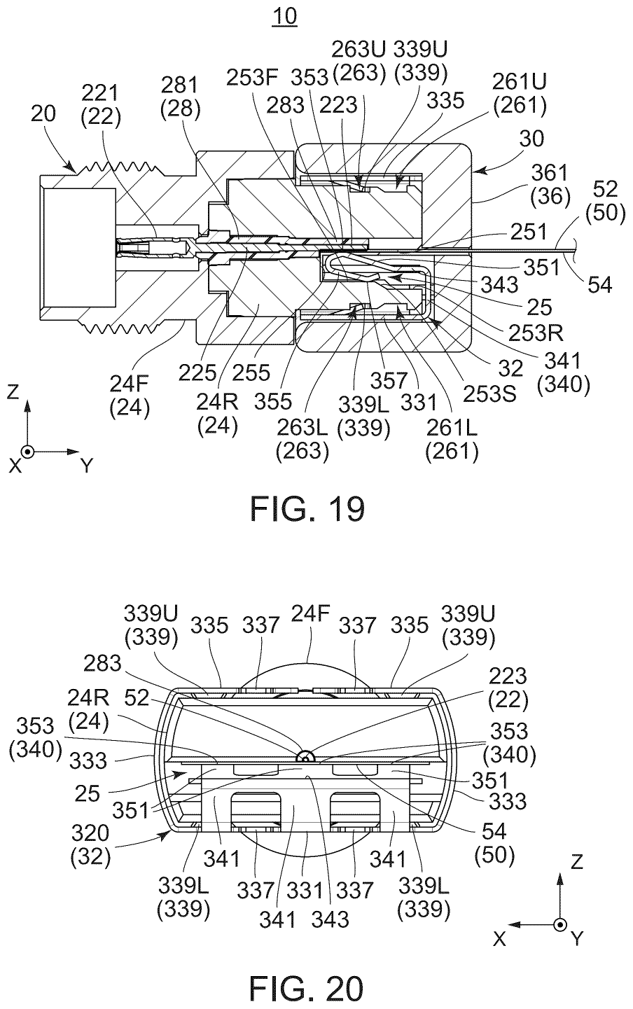

As shown in FIGS. 16 and 17, upon inserting the substrate 50 into the substrate receiving portion 25 of the coaxial connector 10, one end of the substrate 50 is brought into abutment with the front surface 255 of the substrate receiving portion 25. By moving the rear assembly 30 to the second position from this state, the coaxial connector 10 is attached to the substrate 50 as shown in FIGS. 18 and 19.

As understood from FIGS. 17, 19 and 20, when the substrate 50 is inserted into the substrate receiving portion 25, the insertion opening 363 of the external insulator 36 performs positioning of the substrate 50 in each of the up-down direction and the lateral direction and guides movement of the substrate 50 in the front-rear direction. At this time, by passing the substrate 50 through the insertion opening 363 of the external insulator 36, the substrate 50 can be passed through the ground peripheral portion 320. Thus, the ground peripheral portion 320 surrounds a periphery of the substrate 50 in part. In addition, the front surface 255 of the substrate receiving portion 25 serves as an abutment surface for the substrate 50 and performs positioning of the substrate 50 in the front-rear direction.

As understood from FIG. 17, if a size of a distance between the upper contact points 353 and the internal upper surface 251 is larger than a size of a thickness of the substrate 50 when the rear assembly 30 is positioned at the first position, insertion of the substrate 50 into the substrate receiving portion 25 can be carried out by a zero-insertion force. Even if the size of the distance between the upper contact points 353 and the internal upper surface 251 is smaller than the size of the thickness of the substrate 50, upward forces acting from the shell 24 on the first spring portions 351 and the second spring portions 355 is smaller when the rear assembly 30 is positioned at the first position than when the rear assembly 30 is positioned at the second posit. Accordingly, when the rear assembly 30 is positioned at the first position, the insertion of the substrate 50 into the substrate receiving portion 25 can be carried out by a relatively small insertion force.

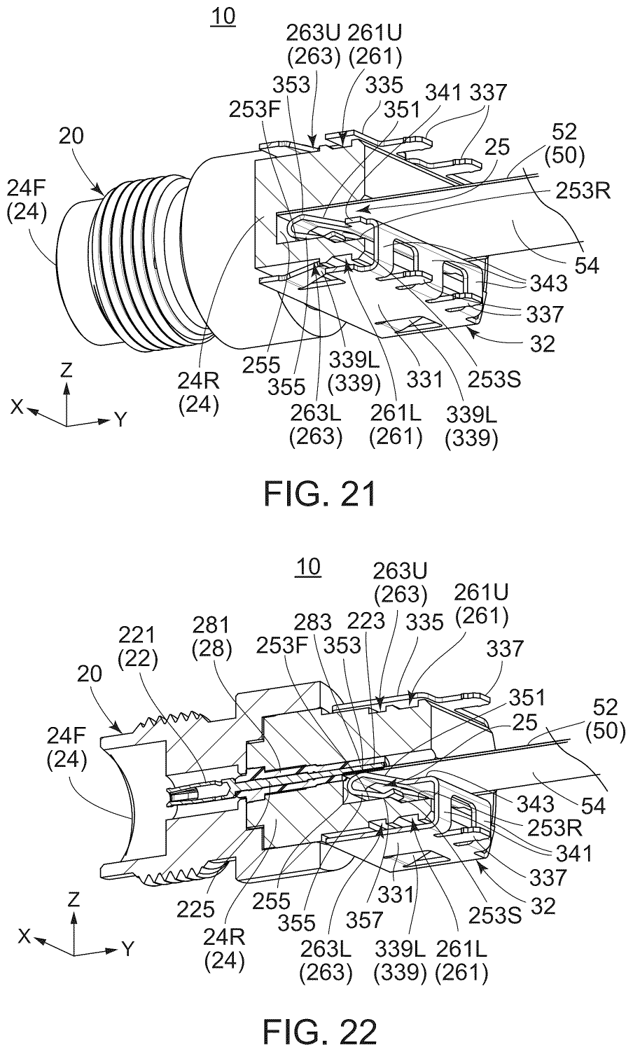

As shown in FIGS. 19, 21 and 22, when the rear assembly 30 is positioned at the second position, the upper contact points 353 are brought into contact with the ground layer 54 of the substrate 50 and push the substrate 50 upward. Accordingly, the signal line 52 of the substrate 50 is pressed on and electrically connected to the rear contact portion 223 of the signal contact 22. Note that, when the ground patterns are formed on the upper surface of the substrate 50, the ground patterns are pressed on the internal upper surface 251 of the substrate receiving portion 25 and electrically connected to the shell 24. Thus, the coaxial connector 10 is attached to the substrate 50 without the use of tools, such as a screw or solder. In addition, it is unnecessary to fold back the substrate 50 in part to bring the ground terminals 340 into contact with the ground layer 54.

In the aforementioned description, the rear assembly 30 is attached to the front assembly 20. However, the rear assembly 30 may be in a state that it is detached from the front assembly 20. In that case, attachment of the coaxial connector 10 to the substrate 50 is carried out as follows.

First, the substrate 50 is inserted into the insertion opening 363 of the external insulator 36 and passed through the ground peripheral portion 320. In a case where the rear assembly 30 does not have the external insulator 36, the substrate 50 is passed through the ground peripheral portion 320 of the ground member 32. Subsequently, the end portion of the substrate 50 is inserted into the substrate receiving portion 25. Next, the ground member 32 is attached to the shell 24 from behind. Alternatively, the rear assembly 30 is attached to the front assembly 20 from behind. At this time, the end of the substrate 50 is brought into abutment with the front surface 255 of the substrate receiving portion 25. Thus, the coaxial connector 10 is in the state shown in FIGS. 16 and 17. After that, upon moving the rear assembly 30 from the first position to the second position, the ground member 32 is moved forward with respect to the shell 24. As a result, as shown in FIGS. 18 to 22, the lower contact points 357 of the ground member 32 ride over the step 253S and are moved from on the first surface 253R to on the second surface 253F. In addition, the upper contact points 353 are moved upward and brought into contact with the ground layer 54 of the substrate 50 and push the substrate 50 upward, so that the signal line 52 of the substrate 50 is brought into contact with the rear contact portion 223 of the signal contact 22. Thus, the coaxial connector 10 is attached to the substrate 50 without the use of tools, such as a screw or solder. In addition, it is unnecessary to fold back the substrate 50 in part to bring the ground terminals 340 into contact with the ground layer 54.

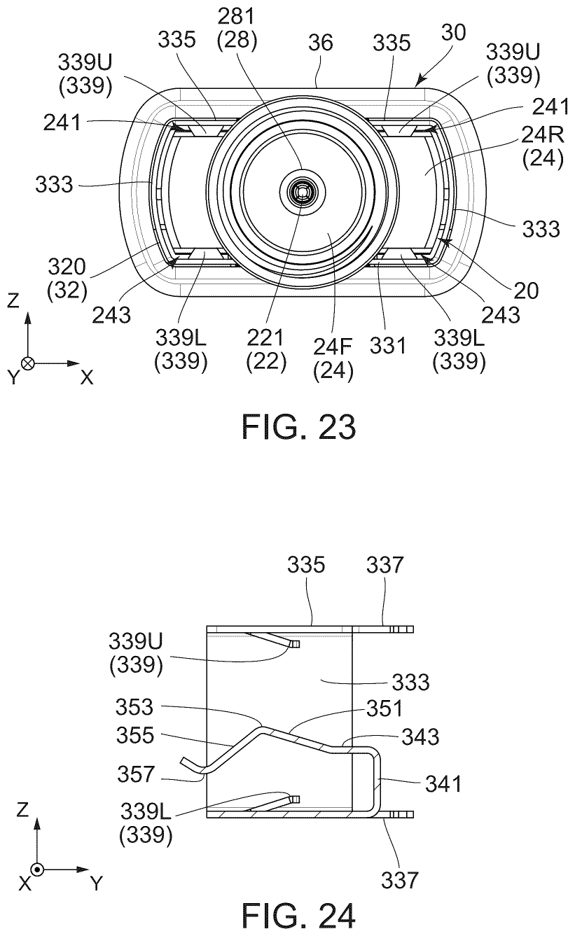

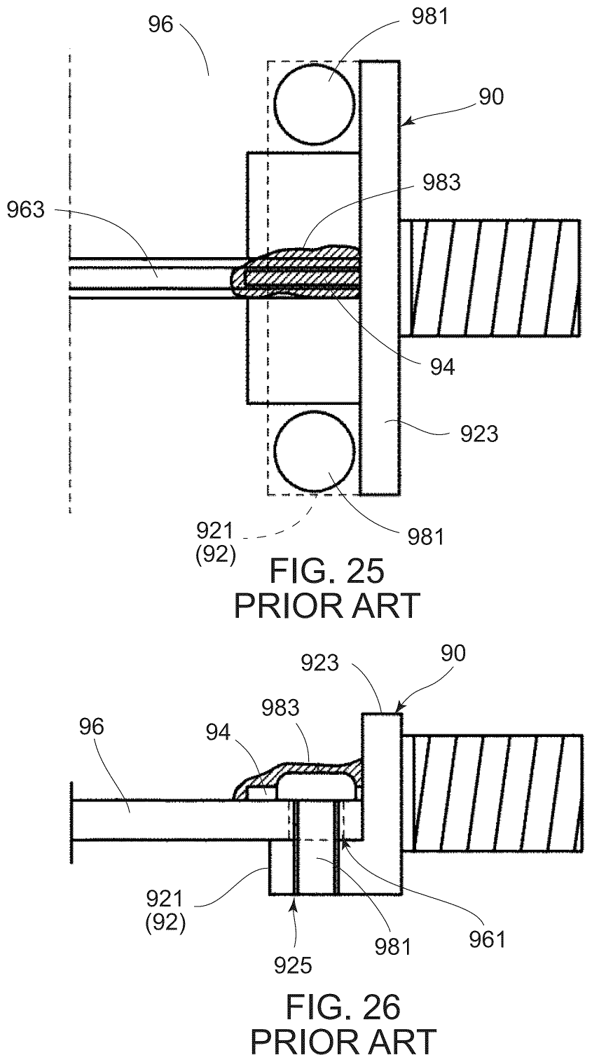

Referring to FIG. 23, in a state that the rear assembly 30 is attached to the front assembly 20 or in the attached state that the ground member 32 is attached to the shell 24, there is a clearance 241 between each of the upper plate portions 335 of the ground member 32 and an upper surface of the rear shell 24R. In addition, there is a clearance 243 between the lower plate portion 331 of the ground member 32 and a lower surface of the rear shell 24R. With this structure, when viewed from a front of the coaxial connector 10 along the front-rear direction, the protruding portions 339 of the ground member 32 are visible. In this structure, the protruding portions 339 can be pushed up or down by the use of a jig (not shown) like a thin plate inserted into each of the clearances 241 and 243 from the front of the coaxial connector 10. Accordingly, the protruding portions 339 can be put out from the second hollow portion 263, and the rear assembly 30 can be moved from the second position to the first position. As a result, the coaxial connector 10 can be detached from the substrate 50.

Although the specific explanation about the present invention is made above with reference to concrete embodiments, the present invention is not limited thereto but susceptible of various modifications and alternative forms without departing from the spirit of the invention.

For example, although the external insulator 36 performs positioning of the substrate 50 in the up-down direction and the lateral direction in the aforementioned embodiment, one or both of the ground terminals 340 and the shell 24 may have a positioning function. In particular, in a case that the coaxial connector 10 does not have the external insulator 36, it is preferable that one or both of the ground terminals 340 and the shell 24 have the positioning function.

Moreover, in the aforementioned embodiment, the lower contact points 357 are located rearward of the upper contact points 353 in the front-rear direction. However, in the present invention, the lower contact points 357 may be located forward of the upper contact points 353 in the front-rear direction as shown in FIG. 24. In this case, the second spring portions 355 extend forward from the upper contact points 353 in the front-rear direction. This structure can give stronger upward forces to the upper contact points 353 in comparison with that shown in FIG. 13. This is effective in a case that the substrate 50 is rigid.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A coaxial connector which is attachable to a substrate, wherein:
the substrate is formed with a signal line on an upper surface thereof and with a ground layer on a lower surface thereof;
the coaxial connector comprises a front assembly and a rear assembly which is attachable to the front assembly from behind in a front-rear direction;
the front assembly comprises a signal contact, a shell made of metal and an internal insulator insulating the signal contact from the shell;
the shell is formed with a substrate receiving portion which opens rearward;
the substrate receiving portion has an internal upper surface and an internal lower surface which are opposite to each other in an up-down direction perpendicular to the front-rear direction;
the internal lower surface is provided with a first surface and a second surface;
the first surface is located rearward of the second surface in the front-rear direction;
the first surface is located downward of the second surface in the up-down direction so that a step is provided between the first surface and the second surface;
the signal contact has a rear contact portion;
the rear contact portion extends along the front-rear direction and is exposed in the substrate receiving portion at least in part;
the rear assembly comprises a ground member made of metal;
the ground member has a ground peripheral portion and a ground terminal;
the ground peripheral portion is attachable to the shell from behind to cover a periphery of the shell:
the ground terminal has a first spring portion which extends from the ground peripheral portion and is resiliently deformable, an upper contact point supported by the first spring portion, a second spring portion which extends from the upper contact point and is resiliently deformable and a lower contact point supported by the second spring portion;
in an attached state that the ground member is attached to the shell, the upper contact point and the lower contact point are located in the substrate receiving portion; and
by attaching the ground member to the shell after passing the substrate through the ground peripheral portion and inserting the substrate into the substrate receiving portion, the lower contact point of the ground member rides over the step and is moved from the first surface onto the second surface, so that the upper contact point is moved upward and brought into contact with the ground layer of the substrate and pushes the substrate upward to bring the signal line of the substrate into contact with the rear contact portion of the signal contact.

2. The coaxial connector as recited in claim 1, wherein when the lower contact point is located on the first surface, a distance size between the upper contact point and the internal upper surface is larger than a thickness size of the substrate.

3. The coaxial connector as recited in claim 2, wherein:
the rear assembly further comprises an external insulator which holds the ground member;
the external insulator is formed with an insertion opening which pierces the external insulator in the front-rear direction;
by passing the substrate through the insertion opening, the substrate is passed through the ground peripheral portion;
when the substrate is inserted into the insertion opening, the insertion opening positions the substrate in the up-down direction and a lateral direction perpendicular to both the front-rear direction and the up-down direction and guides the substrate in the front-rear direction; and
the upper contact point is located downward of the insertion opening in the up-down direction.

4. The coaxial connector as recited in claim 1, wherein the lower contact point is located rearward of the upper contact point in the front-rear direction.

5. The coaxial connector as recited in claim 1, wherein the internal insulator has a reinforcing portion located between the rear contact portion and the shell.

6. The coaxial connector as recited in claim 1, wherein:
the rear assembly is attached to the front assembly so that the rear assembly is movable from a first position to a second position in the front-rear direction;
the first position is located rearward of the second position in the front-rear direction;
the ground peripheral portion is formed with a protruding portion which protrudes inward in a perpendicular plane perpendicular to the front-rear direction;
the shell is provided with a first hollow portion and a second hollow portion which are depressed inward in the perpendicular plane;
the first hollow portion is located rearward of the second hollow portion in the front-rear direction;
when the rear assembly is positioned at the first position, the protruding portion is received by the first hollow portion; and
upon moving the rear assembly to the second position, the protruding portion is moved from the first hollow portion toward the second hollow portion and received by the second hollow portion, therein the ground peripheral portion and the shell are connected to each other.

7. The coaxial connector as recited in claim 6, wherein:
the protruding portion has an upper protruding portion and a lower protruding portion;
the first hollow portion has a first upper hollow portion and a first lower hollow portion;
the second hollow portion has a second upper hollow portion and a second lower hollow portion;
when the rear assembly is positioned at the second position, the upper protruding portion is received by the second upper hollow portion, therein the ground peripheral portion is connected to the shell; and
when the rear assembly is positioned at the second position, the lower protruding portion is received by the second lower hollow portion, therein the ground peripheral portion is also connected to the shell.
